(19) United States
(12) Patent Application Publication
(10) Pub. No.: US 2026/0252316 A1
(43) Pub. Date: Aug. 27, 2026

(54) SOURCE CODE VIEW PARTITIONING FOR PRODUCTIVE INNER LOOP IN HIGH PERFORMANCE SYSTEMS

(71) Applicant: MICROSOFT TECHNOLOGY LICENSING, LLC, Redmond, WA (US)

(72) Inventors: Ion TODIREL, Redmond, WA (US); Bogdan Ionut MIHALCEA, Sammamish, WA (US)

(21) Appl. No.: 19/059,757

(22) Filed: Feb. 21, 2025

(51) Int. Cl. G06F 8/30

(52) U.S. Cl. CPC G06F 8/30

(57) ABSTRACT

Systems and methods are provided for facilitating the management of code during software development by dynamically partitioning the code and by generating visualizations of logical presentations of the partitioned code. Context and scope are determined for the code. The code is partitioned according to the determined context and scope. Partitioned segments are presented within a coherent virtual file view while omitting less relevant code from the coherent virtual file view. The partitioned view can help facilitate navigation and editing efficiencies during code development, particularly for large source files.

### BACKGROUND

In the field of software development, developers frequently encounter the issue of handling massive source files. These files can range from a few hundred to tens of thousands of lines of code, making them difficult to navigate and edit. The complexity of managing such extensive files can lead to significant productivity losses, as developers must often switch contexts while moving between different parts of the files. This constant context switching can result in cognitive overload, decreased efficiency and an increase in the likelihood of mistakes.

In an attempt to be more consistent and efficient, some developers may combine many incremental builds into a single jumbo build. However, current systems and interfaces used for handling the jumbo builds, and the inner loops of each of the corresponding incremental builds, do not provide adequate tools to present a clear understanding of what parts of the code are being changed with each inner loop. Consequently, as the size of the jumbo build increases, the problems associated with context switching can become even more pronounced, ironically resulting in a net decrease in efficiency and a net increase in the likelihood of mistakes.

In view of the foregoing, there is an ongoing need and desire for improved systems and methods for managing source code during software development, and particularly for navigating expansive code for jumbo builds.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

Systems and methods are provided for facilitating the management of code during software development by dynamically partitioning the code and by generating visualizations of logical presentations of the partitioned code. Context and scope are determined for the code. The code is partitioned according to the determined context and scope. Partitioned segments are presented within a coherent virtual file view while omitting less relevant code from the coherent virtual file view. The partitioned view can help facilitate navigation and editing efficiencies during code development, particularly for large source files.

In some aspects, methods are provided for dynamically generating a logical presentation of partitioned code, the methods including: identifying code from a predefined set of files for presentation to a user within an IDE (integrated development environment); identifying a defined context associated with the use of the code; identifying a defined scope for generating a logical presentation of partitioned code based on the defined context; based on (i) the defined context and (ii) the defined scope, partitioning the code to identify partitioned code segments of the code that are determined to be relevant to the defined context and within the defined scope for generating a contextually partitioned coherent virtual file view of the partitioned code segments, the partitioned code segments being distinguished from other portions of the code that are determined to be less relevant to the defined context and/or outside of the defined scope for generating the logical presentation of partitioned code; generating a memory mapping for the partitioned code segments that identifies lines of the code to include with each partitioned code segment of the partitioned code segments; and generating and displaying a contextually partitioned coherent virtual file view of the partitioned code segments based on the memory mapping that omits the other portions of the code.

In some aspects, the methods further include reformatting at least some partitioned code segments in the contextually partitioned coherent virtual file view with different formatting than is used to present the code within a comprehensive build view of the code displayed to the user.

In some aspects, the techniques described herein relate to methods for dynamically modifying a presentation of partitioned code, the methods including: displaying a contextually partitioned coherent virtual file view of partitioned code segments from code included in one or more source code files based on a defined context and a defined scope, the contextually partitioned coherent virtual file view of partitioned code segments omitting at some portions of the code included in the one or more source code files based on the defined context and the defined scope; detecting a change that results in a new defined context or a new defined scope for generating an updated contextually partitioned coherent virtual file view of partitioned code segments; in response to the detected change, generating the updated contextually partitioned coherent virtual file view of partitioned code segments, the updated contextually partitioned coherent virtual file view of partitioned code segments including a second set of code that is different than a first set of code included in the contextually partitioned coherent virtual file view of partitioned code segments; and displaying the updated contextually partitioned coherent virtual file view of partitioned code segments in a manner to visually distinguish the second set of code for the updated contextually partitioned coherent virtual file view of partitioned code segments from the first set of code for the contextually partitioned coherent virtual file view of partitioned code segments.

In some aspects, computing systems are configured with one or more hardware processors and stored computer-executable instructions that are executable by the one or more processors to implement the disclosed methods.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates a computing environment that may be utilized to implement the disclosed methods for facilitating the management and partitioning of code.

FIG. 2 illustrates a flowchart of acts associated with methods for facilitating the management and partitioning of code.

FIG. 3A-3E illustrate examples of contextually partitioned coherent virtual file views of code obtained from code and based on context and scope filters used to partition the code.

FIG. 4A-4C illustrate examples of contextually partitioned coherent virtual file views of code being presented within user interface displays.

### DETAILED DESCRIPTION OF THE INVENTION

As disclosed herein, systems and methods are provided for facilitating the management of code during software development by dynamically partitioning the code and by generating visualizations of logical presentations of the partitioned code. The partitioning of the code is based on context and scope determined for the code.

Beneficially, the disclosed embodiments can be utilized to facilitate software development, where a single large source file can be partitioned into one or more virtual files that only visualize relevant portions of the underlying source code. Such partitioning can be thought of as virtual refactoring, where functions, classes and member functions can be moved around and reordered, but only virtually, without affecting the underlying structure of the source code files. Configuration files and other memory mapping data structures are used to store the partition information to facilitate the virtual mapping of partitions across multiple physical files, further simplifying developer workflow which otherwise would not be efficient to do with traditional systems.

Another benefit that can be realized from implementing the disclosed embodiments is an enhanced design time experience for the developers of the source code. In particular, by facilitating the generation of different contextually partitioned coherent virtual file views, a developer is enabled to see the code in different ways, according to different defined scopes and contexts, which can facilitate an increase in creativity for the developer, while reducing context switching within each of the different single views that omit potentially irrelevant code for each of the different context and scoped views.

As described throughout, the partitioning of the source code is based on the determined context and scope of the associated code being developed. In this regard, it will be appreciated that the term context, as used herein, should be broadly construed as the relevance of circumstantial and situational information associated with the development of code as that information is considered to be applicable to the different contextual situations. There are different types of contextually relevant information that may be considered when partitioning the code based on context. By way of example, contextual information can include, but is not limited to user context (e.g., a particular user, entity or third-party associated with development or use of the code), task and application context (e.g., a function or manner of utilizing the code in an application), historical use data (e.g., a manner in which the code has been and is used in other applications), location or device context (e.g., systems and enterprises that utilize the code), codebase contexts (e.g., specific programming language and the types of classes, functions and declarations used in the code, as well as dependencies), temporal context (e.g., a past use, present use and new input, and/or future or anticipated use context), and even social or enterprise contexts (e.g., user or group assignment, privileges, confidentiality), and so forth.

The context information may be obtained, for example, from files, applications and systems that track user profiles, user interactions, application performance, heuristics and task descriptions that correspond to different situations in which code may be developed. Predefined rules can control how different context information is evaluated and weighted in terms of relevance for the different situations and circumstances in which code may be developed (e.g., for different users, for different tasks, for different programming languages).

Machine learning models are trained to identify context information and can be utilized to process user, application and system resources to identify the context information. The machine learning models and predefined rules can also be utilized to evaluate information to determine whether the identified context information is relatively more relevant or less relevant in defining the particular context for the code that is being processed in a particular situation.

The term scope, as used herein, generally relates to the boundaries and extent of a specific task or project for code development. The scope may be based on the location of the code (e.g., namespace or storage location of the source code file(s)). The scope may also be based on a particular module, feature or function of code being developed and will include all of the portions or lines of code that are functionally related. By way of example, a scope for refactoring a particular module will include the lines of code corresponding to the functions and classes of the particular module, while omitting lines of code that are not materially or functionally relevant to the functions and class of the particular module. The scope may also limit or define specific classes, types and functions in the code. In some instances, the scope may also be proximity-based, such that the scope of code associated with a particular function or module being developed and will include a predefined number of bounding lines of code that precede and/or follow any lines of code that are determined to correspond to the particular function or module being developed.

The disclosed systems determine the context and scope of the code being developed for a particular situation (e.g., user and/or task) and partition the code into a virtual file that includes code that is determined to be contextually relevant and within the defined scope and that omits code that is not determined to be contextually relevant and/or within the defined scope. The partitioned code is then presented to a user in a contextually partitioned coherent virtual file view, thereby reducing context switching during the code development and facilitating efficiencies in navigating the code being developed.

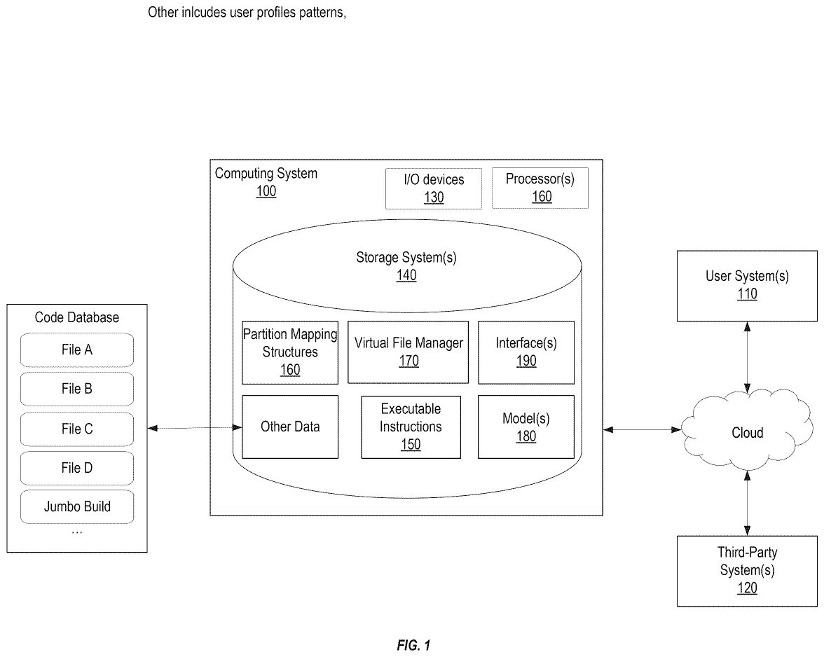

Attention is now directed to FIG. 1, which illustrates a computing system that can be utilized to facilitate the management and partitioning of code, as described herein. As shown, the computing system 100 is in communication with one or more user system(s) 110 and/or third-party system(s) 120. In some implementations, the user system(s) 110 and third-party system(s) 120 are remotely located from the computing system 100 and are independently controlled computing systems. In other implementations, the user system(s) 110 and/or third-party system(s) 120 comprise distributed components of the computing system 100, such that they share storage and processing capabilities.

Computing system 100 is connected to the other user system(s) 110 and third-party system(s) 120 through a network of wired and/or wireless connections, such as currently represented as the cloud.

Each of the illustrated systems includes input and output devices (I/O devices 130) for receiving inputs and rendering outputs, respectively, even though they are only explicitly shown for computing system 100. Non-limiting examples of input devices include microphones, keyboards, mouse devices, touch pads, and camera sensors. Non-limiting examples of output devices include speakers, desktop display screens, mixed-reality display devices, and haptic feedback devices.

The disclosed systems also include one or more storage system(s) 140 of volatile and/or non-volatile storage and one or more hardware processor(s) configured to execute the executable instructions 150 stored in the storage system(s) 140 to cause the computing system 100 to implement the methods and functionality disclosed herein.

The storage system(s) 140 also store the partition mapping structure(s) 160 that track the location and lines of code or offsets that correspond to each of the different partitions that are created for the different determined contexts and scopes. Notably, different context and scope partitions can be created for different combinations of contextual information (e.g., different users, applications, times, locations, uses, tasks or any other combinations of contextual information) as well as different codebase scopes (e.g., code function or module scope, code source location scope or bounding proximity).

The storage system(s) 140 also store a virtual file manager 170 that is configured to determine the contexts and scopes used to partition the code and to manage the partition mapping structures, as well as to control the presentation of the contextually partitioned coherent virtual file views. The virtual file manager 170 uses one more model(s) 180 to identify the context information and to determine the context of a particular situation, as generally referenced above. The model(s) 180 can include neural networks, classification models, and large language models that identify and classify context information when analyzing the contents of different user, application and third-party resources. The models can also include separate or integrated ranking models that rank the relative contextual information to determine the context for different situations.

Some of the model(s) 180 are also configured to process source code files to identify relevant portions of source code that correspond to a defined scope. The defined scope may be based on a determined context (e.g., a particular module or task assigned to a developer and/or storage namespace or location of the code). The defined scope may also be based on explicit user input that specifies the defined scope (e.g., a specified function, module, relevant lines of code, bounding lines of code, etc.).

Different interfaces 190 are used by the virtual file manager to interface with the different model(s) 180, to interface with other system components and remote systems, as well as to present the contextually partitioned coherent virtual file views to the end user (e.g., developer). The interfaces 190 can include or utilize integrated development environments (IDEs), such as Microsoft's Visual Studio to present the contextually partitioned coherent virtual file views.

The storage system(s) 140 also store other data used to implement the functionality described herein. This other data may include, for example, code databases that include and store the actual source code files being partitioned into the contextually partitioned coherent virtual file views.

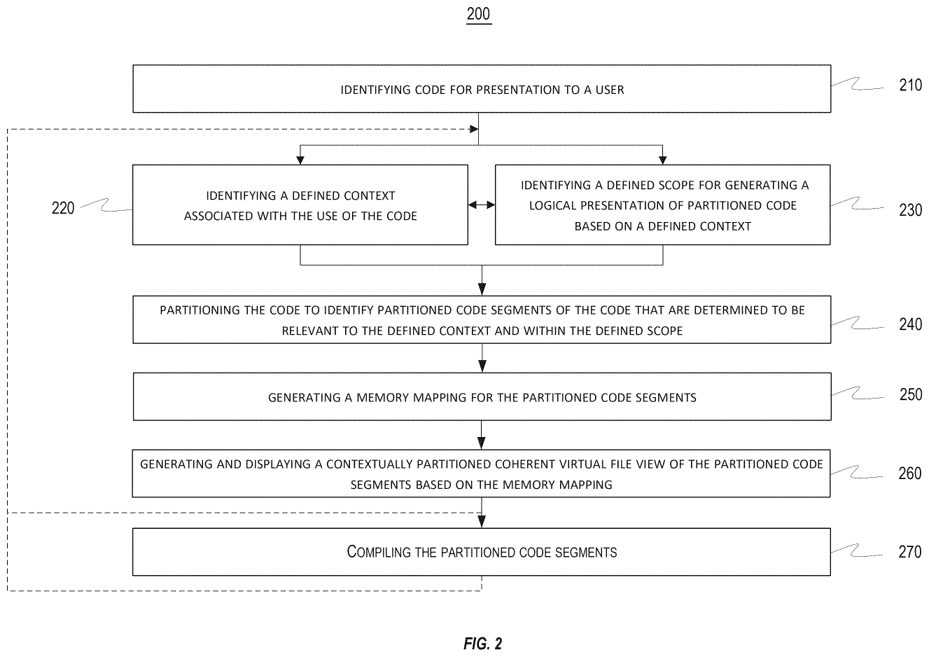

As noted above, computing system 100 can be utilized to implement the disclosed methods, including the methods associated with the acts that are illustrated in flowchart 200 of FIG. 2 for facilitating the management of code during software development by dynamically partitioning the code and by generating visualizations of logical presentations of the partitioned code, wherein the partitioning of the code is based on context and scope determined for the code.

As shown, these acts include identifying code from a predefined set of files for presentation to a user (act 210), such as within an IDE. This code comprises source code that is stored in one or more files. In some instances, the source code may include code from many different files configured into a jumbo build. The jumbo build may be compiled as a single file and/or be stored as a plurality of files that each contain different portions of the jumbo build.

The disclosed acts also include identifying a defined context associated with the use of the code (act 220) and identifying a defined scope for generating a logical presentation of partitioned code based on the defined context (act 230), as previously discussed.

Then, based on (i) the defined context and (ii) the defined scope, the code is partitioned to identify partitioned code segments of the code that are determined to be relevant to the defined context and within the defined scope (act 240). The partitions created during the partitioning are virtual partitions, in some instances, which identify the source code files and the specific locations (e.g., lines) within the files of source code where the virtual partitions reside.

A memory mapping is generated to identify and manage the virtual partitions to facilitate the identification of the contextually relevant source code that is included within each defined partition (act 250). The memory mapping can include an index, configuration file, or other data structure that identifies the constituent portions of code for each partition (e.g., lines of code) and the locations of those code portions within each of the stored source code files. The memory mapping is dynamic and is updated as the source code is modified.

The disclosed acts also include generating a contextually partitioned coherent virtual file view of the partitioned code segments (act 260). Notably, the partitioned code segments are distinguished from other portions of the code that are determined to be less relevant to the defined context and/or outside of the defined scope for generating the logical presentation of partitioned code. The generation of the contextually partitioned coherent virtual file view of the partitioned code segments is based on the aforementioned memory mapping, which may be updated based on changes to the source code, as well as changes in the determined context and/or scope associated with the code and virtual partition(s). In some instances, for example, the determined context or scope may change in response to new contextual information (e.g., new user input specifying or qualifying a scope or context for the code development, a change in users associated with the code, or any other change associated with the code, including a newly anticipated use of the code).

In some instances, the virtual files containing the contextually relevant code within the defined scope are then compiled (act 270) to perform debugging and runtime processes. The compiling of the virtual files may occur, for example, by stitching together the underlying code of the portioned segment(s) based on the memory mapping that identifies the locations of the corresponding code.

While the foregoing descriptions have been provided with reference to virtual partitions and virtual files, it will be appreciated that the scope of this disclosure is not limited to virtual files. For instance, in some alternative embodiments, the partitions are actual partitions used to define the portions of code to be saved together as a separate set of one or more files that include the actual lines of code determined to be contextually relevant and within the defined scope. The use of actual files may be desirable in some instances, for example, to facilitate the compiling of discrete portions of a jumbo build, which may correspond to a discrete function or application, separately from other portions of the comprehensive jumbo build codebase that relate to different applications or functions.

It will be appreciated that there are also other variations to the foregoing methods that can be performed to facilitate the disclosed techniques for managing and partitioning code.

By way of example, in some instances, the identification of code to present to a user (act 210) may include identifying code specified by a user, such as when a user selects a file from a menu option or types in the namespace of the file into a system interface. In some instances, the code that is identified may also include content obtained from a source other than a predefined set of files specified by a user, such as may be obtained after identifying a defined scope or context for the code. This may be useful, for example, by searching third-party databases with a LLM or other tool for code examples and code updates that are relevant to the defined context of code that was initially identified by the user.

In some instances, the disclosed embodiments also include reformatting at least some partitioned code segments in the contextually partitioned coherent virtual file view with different formatting (e.g., highlighting or font styles) than a formatting used to present the code within a build view that comprehensively includes the partitioned code segments with other code that is not included with the partitioned code segments. This can help facilitate the developer's tasks in reviewing and processing the code during development.

In some instances, the contextually partitioned coherent virtual file view of the partitioned code segments is presented in a first window or display concurrently while presenting a build view of the code in a second window. In some alternative embodiments, the contextually partitioned coherent virtual file view is presented without presenting the full build view and/or only after first receiving user input that specifies that the contextually partitioned coherent virtual file view should be presented. That user input can be received from a control displayed with the full build view, for example.

In some embodiments, the techniques described herein relate to a method for dynamically modifying a presentation of partitioned code based on detecting a change that results in a new defined context or a new defined scope for generating an updated contextually partitioned coherent virtual file view of partitioned code segments. Such as detected change, for example, can trigger the generation of an updated contextually partitioned coherent virtual file view of partitioned code segments, where the updated contextually partitioned coherent virtual file view of partitioned code segments includes a second set of code that is different than a first set of code included in the initial contextually partitioned coherent virtual file view of partitioned code segments. This also triggers the subsequent display of the updated contextually partitioned coherent virtual file view of partitioned code segments, in some instances, in a manner to visually distinguish the second set of code for the updated contextually partitioned coherent virtual file view of partitioned code segments from the first set of code for the contextually partitioned coherent virtual file view of partitioned code segments. The initial/first contextually partitioned coherent virtual file view and the updated/second contextually partitioned coherent virtual file view can be displayed concurrently within the same or different displays or windows. Alternatively, they may only be displayed sequentially (e.g., by replacing the initial/first contextually partitioned coherent virtual file view with the updated/second display of the updated contextually partitioned coherent virtual file view) in the same or different displays or windows.

When the systems are used to generate both initial contextually partitioned coherent virtual file views and updated contextually partitioned coherent virtual file views, the systems may compile the code for the different views separately.

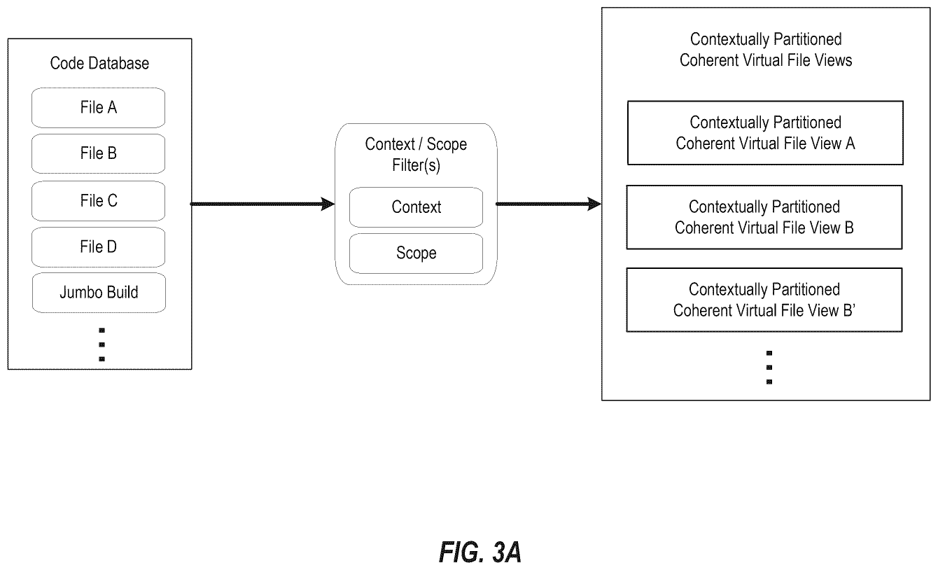

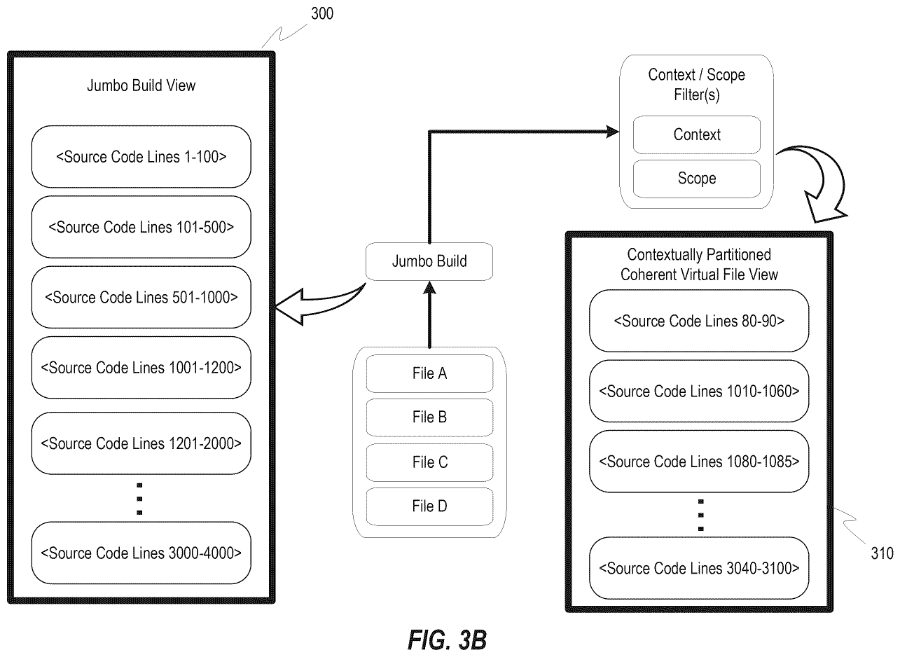

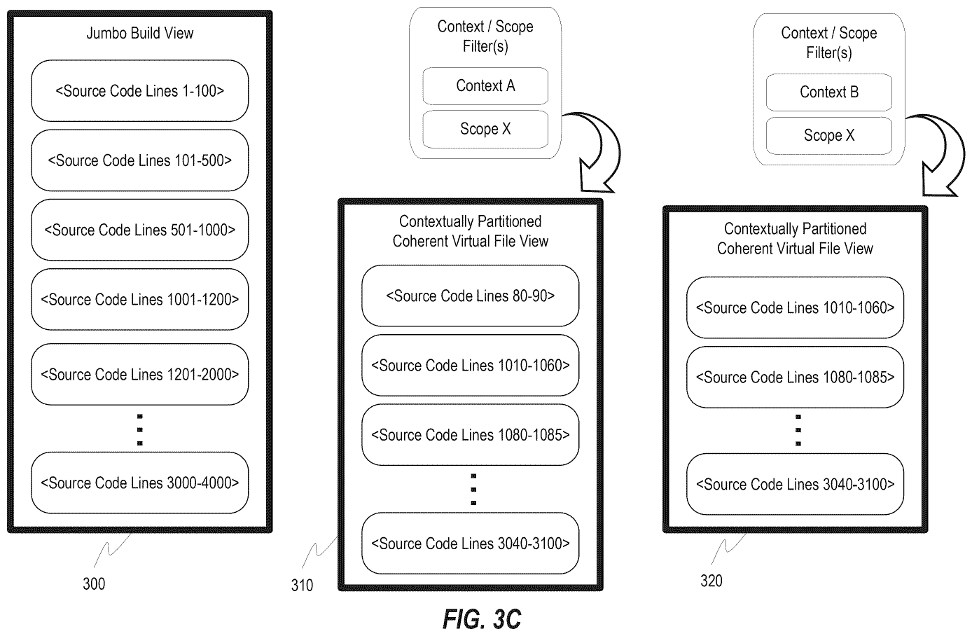

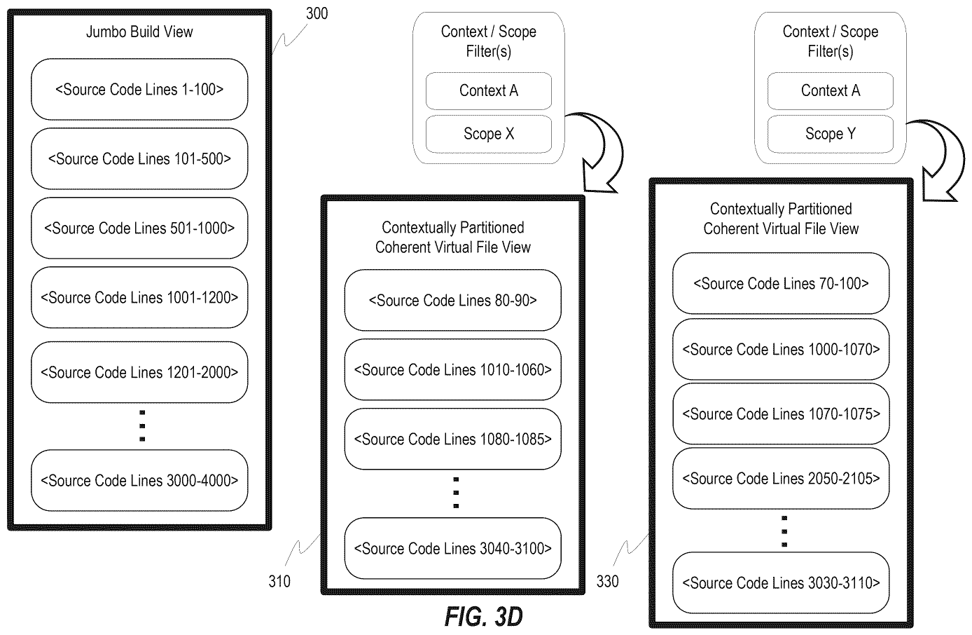

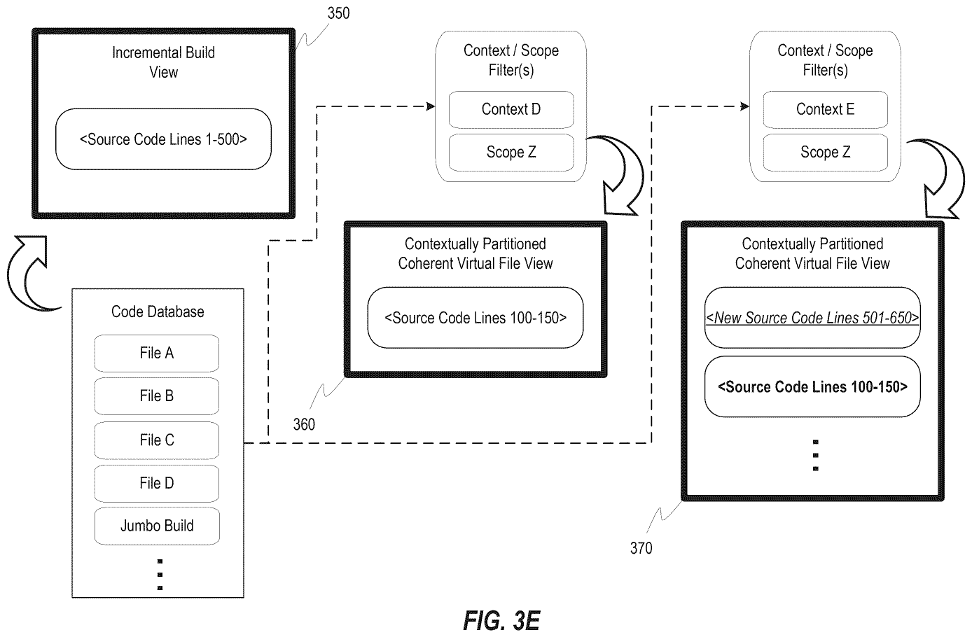

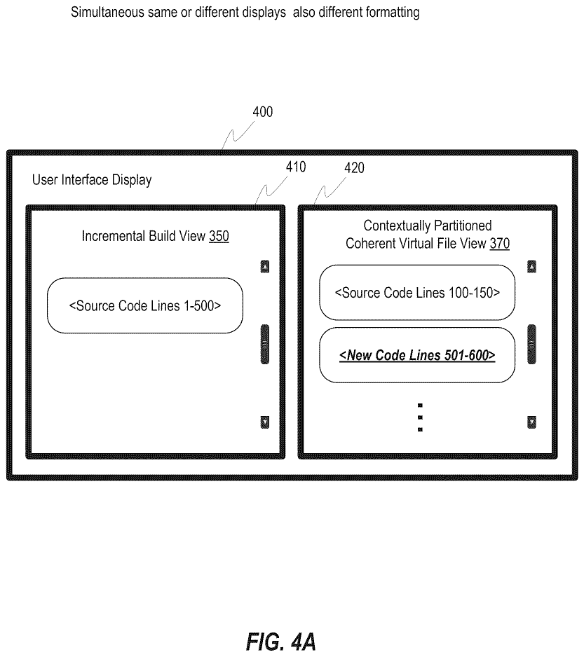

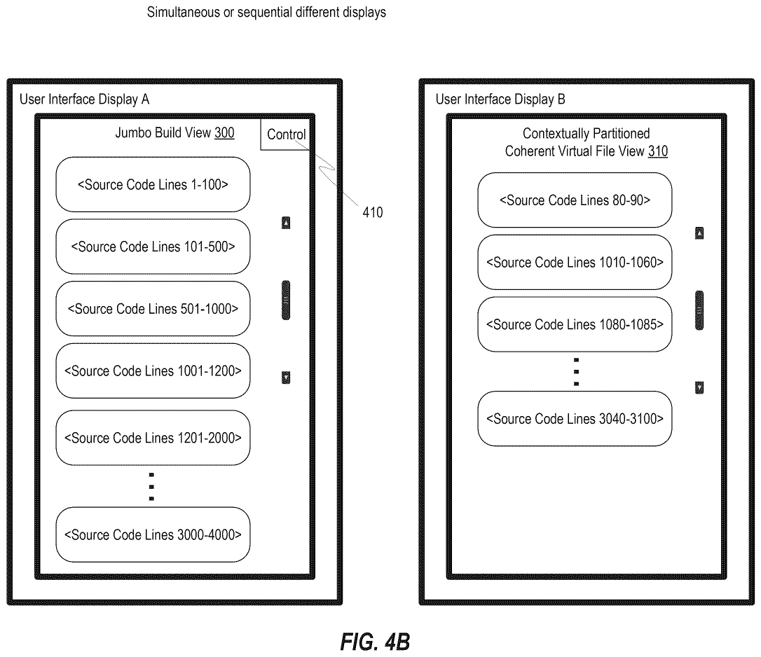

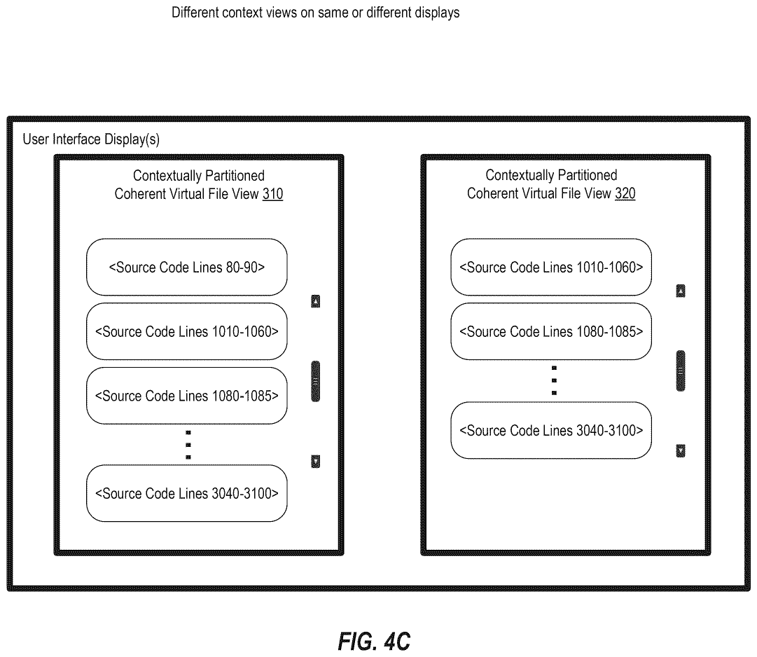

Attention will now be directed to FIGS. 3A-4C, which illustrate non-limiting examples of contextually partitioned coherent virtual file views generated for different contexts and scopes and that may be displayed with other views of the corresponding code at one or more interfaces (e.g., IDE interfaces) according to the disclosed methods described above.

As shown in FIG. 3A, a codebase includes several discrete files and a jumbo build that also comprises a single composite file that includes one or more of a plurality of the discrete files (e.g., File A, File B, File C, File D) and/or particular portions of those files. The jumbo build and the incremental builds referenced herein may be physical files or only virtual files that include pointers to constituent parts of the underlying files. The referenced files (individual, jumbo and incremental files) can be stored locally and/or remotely to the systems that determine the context and scope of filters to use for generating the partitioned segments of the underlying source code in the files.

As shown, the determined contexts and scopes are used by the system to generate the contextually partitioned coherent virtual file views of the different code being processed for display to the user. In this example, Contextually Partitioned Coherent Virtual File View A corresponds to a different context and/or scope than Contextually Partitioned Coherent Virtual File View B and Contextually Partitioned Coherent Virtual File View B′ corresponds to an updated version of Contextually Partitioned Coherent Virtual File View B that was generated after generating Contextually Partitioned Coherent Virtual File View B, based on new updated context information and/or scope definitions.

FIG. 3B illustrates how a jumbo build file can be based on several underlying files (e.g., File A, File B, File C and File D) and used to generate a jumbo build view 300 the comprehensive source code from those files, such as may be displayed in an IDE. Additionally, a separate Contextually Partitioned Coherent Virtual File View 310 can also be generated based on the context and scope filters that determined for a current situation, as disclosed above. Notably, the Contextually Partitioned Coherent Virtual File View 310 includes only limited portions of the underlying code from the jumbo build that is determined to be contextually relevant and within a defined scope, while omitting other portions that are not determined to be materially relevant and/or within the defined scope. (e.g., including source code lines 80-90, while omitting source code lines 1-70 and 90-1009, for example).

FIG. 3C illustrates how the Contextually Partitioned Coherent Virtual File View 310 can be generated from the underlying code used to generate the Jumbo Build View 300, based on a first context (Context A) and a first scope (Scope X), while a different Contextually Partitioned Coherent Virtual File View 320 can be also be generated off the same underlying code but be partitioned differently based on a different context (Context B). In this example, the Contextually Partitioned Coherent Virtual File View 320 includes different partitioned code segments than presented in Contextually Partitioned Coherent Virtual File View 310, even though they have the same determined scope (Scope X), because they are based on different determined contexts.

In the example of FIG. 3D a first Contextually Partitioned Coherent Virtual File View 310 and a second Contextually Partitioned Coherent Virtual File View 330 are based on the same context (e.g., a same function or module defined as Context A), but different scopes (e.g., different boundary requirements of bounding lines of code preceding and following the contextually relevant code). In this example, Scope X does not require additional bounding lines of code, wherein Scope Y requires 10 lines of code preceding and following any contextually relevant code to be included in the partitioned segment(s).

FIG. 3E illustrates an example in which a codebase is used to generate an Incremental Build View 350 corresponding to an incremental build of one or more files of the source code. In this example, the incremental build is less inclusive than the jumbo build and may be limited to only a single file or only a portion of a file.

In this example, a defined context (Context D) and scope (Scope Z) associated with the incremental build is used to generate a first Contextually Partitioned Coherent Virtual File View 360, while a second context (Context E) is used with the defined scope (Scope Z) to generate a second Contextually Partitioned Coherent Virtual File View 370 of the incremental build. In this example, the first and second contexts may be dynamically updated in response to detected conditions, e.g., different users accessing the incremental build source code. Or, the contexts may correspond to newly discovered third-party content (e.g., updates to encryption standards referenced in the source code, such as a requirement for using a linked standard that has been updated from SHA2 to SHA3). An updated condition could also be a detected use, edit or access of the source code by different entities, or any other newly detected context or scope information.

In this example, the presentation of the Contextually Partitioned Coherent Virtual File View 370 includes using different formatting than used to visually present the source code in the other views of the source code (e.g., source code lines 100-150 are highlighted or bolded and new source code lines 501-650 are presented in italics). It will be appreciated that different types of formatting can be used, including highlighting and font types and styles to visually distinguish the source code in different views. This can be helpful for a developer to see portions of the source code that are determined to be contextually more relevant to the developer than other portions of the source code that are visualized and/or that correspond to different types of the different contexts or scopes (e.g., a first font for a first determined context and scope and a second font for a different context or scopes) that are all used to generate the partitioned code segments included in the view. As shown, the different formatting may also include repositioning the portions of code included in the partitioned segment(s) differently between the different views (e.g., source code lines presented at the top of Contextually Partitioned Coherent Virtual File View 360, but behind other new source code in Contextually Partitioned Coherent Virtual File View 370).

FIGS. 4A, 4B and 4C illustrate how the different contextually partitioned coherent virtual file views can be presented in a single interface display and/or in separate interface displays and/or windows. The presentations of the different contextually partitioned coherent virtual file views can occur simultaneously and concurrently, as well as at different times in sequential presentations, as previously mentioned.

As shown in FIG. 4A, a single user interface display 400 (e.g., an IDE interface) is used to render two different windows, with a first window 410 rendering the Incremental Build File View 350 of FIG. 3E and a second window 420 rendering the related Contextually Partitioned Coherent Virtual File View 370 of FIG. 3E. These views are rendered concurrently in some embodiments. In other embodiments, they are rendered independently of each other at different times.

FIG. 4B illustrates the Jumbo Build View 300 and the Contextually Partitioned Coherent Virtual File View 310 of FIG. 3B being rendered at separate interface displays. In this embodiment, the different interface displays are separate instances of a single IDE application. As such the different interface displays can be rendered as separate windows on a single display device, or as separate interfaces rendered on two different and physically distinct display devices.

In some instances, the Jumbo Build View 300 is rendered with a control that is selectable and which is operable (when selected) to trigger the generation and/or display of the Contextually Partitioned Coherent Virtual File View 310. This control may include one or more menus and input fields for identifying contextual information and scoping information used to determine the context and scope to use for generating the Contextually Partitioned Coherent Virtual File View 310.

Finally, as shown in FIG. 4C, an updated Contextually Partitioned Coherent Virtual File View 320 can be displayed concurrently with a corresponding Contextually Partitioned Coherent Virtual File View 310 that is generated from the same underlying source code, based on different scopes and/or contexts associated with the different views. In some instances, as described in FIG. 3C, the updated Contextually Partitioned Coherent Virtual File View 320 may be based on an updated context and/or scope that was used to generate the Contextually Partitioned Coherent Virtual File View 310 and which is updated after generating and/or rendering the Contextually Partitioned Coherent Virtual File View 310. In such instances, the updated Contextually Partitioned Coherent Virtual File View 320 may replace the display of the Contextually Partitioned Coherent Virtual File View 310. Alternatively, both views may be displayed at the same time.

This example is provided to illustrate one benefit of the disclosed embodiments for enabling a developer to dynamically evaluate source code with different views and according to different scopes and contexts that may be of interest to the developer, and while also reducing a potential need for context switching within any single view.

Jumbo Build View 300 is rendered with a control that is selectable and which is operable (when selected) to trigger the generation and/or display of the Contextually Partitioned Coherent Virtual File View 310.

As noted earlier, the disclosed methods and functionality may be performed by computing system 100, which may take various different forms and which may include and/or be in communication with one or more user systems and third-party system.

For example, computing system 100 may be embodied as a tablet, a desktop, a laptop, a mobile device, or a standalone device, such as those described throughout this disclosure. Computing system 100 may also be a distributed system that includes one or more connected computing components/devices that are in communication with computing system 100.

In its most basic configuration, computing system 100 includes various different components, such as the referenced processors. Without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computing system 100. The different components, modules, engines, and services described herein may be implemented as objects or processors that execute on computing system 100 (e.g. as separate threads).

The referenced storage system(s) may be physical system memory, which may be volatile, non-volatile, or some combination of the two. The term “memory” may also be used herein to refer to non-volatile mass storage such as physical storage media. If computing system 100 is distributed, the processing, memory, and/or storage capability may be distributed as well.

The storage system(s) may include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 100 may also be connected (via a wired or wireless connection) to external sensors (e.g., one or more remote cameras) or devices via a network defined as one or more data links and/or data switches that enable the transport of electronic data between computer systems, modules, and/or other electronic devices. For example, computer system 100 can communicate with any number of devices or cloud services to obtain or process data. In some cases, the network may itself be a cloud network (e.g., the cloud shown in FIG. 1). Furthermore, computer system 100 may also be connected through one or more wired or wireless networks to remote/separate computer systems(s) that are configured to perform any of the processing described with regard to computer system 100.

When information is transferred, or provided, over a network (either hardwired, wireless, or a combination of hardwired and wireless) to a computer, the computer properly views the connection as a transmission medium. Computer system 100 will include one or more communication channels that are used to communicate with the network. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention can also be described in accordance with the following numbered clauses.

Clause 1. A method for dynamically generating a logical presentation of partitioned code, the method comprising: identifying code from a predefined set of files for presentation to a user within an IDE (integrated development environment); identifying a defined context associated with the use of the code; identifying a defined scope for generating a logical presentation of partitioned code based on the defined context; based on (i) the defined context and (ii) the defined scope, partitioning the code to identify partitioned code segments of the code that are determined to be relevant to the defined context and within the defined scope for generating a contextually partitioned coherent virtual file view of the partitioned code segments, the partitioned code segments being distinguished from other portions of the code that are determined to be less relevant to the defined context and/or outside of the defined scope for generating the logical presentation of partitioned code; generating a memory mapping for the partitioned code segments that identifies lines of the code to include with each partitioned code segment of the partitioned code segments; and generating and displaying a contextually partitioned coherent virtual file view of the partitioned code segments based on the memory mapping that omits the other portions of the code.

Clause 2. The method of clause 1, wherein the method further includes reformatting at least some partitioned code segments in the contextually partitioned coherent virtual file view with different formatting than is used to present the code within a build view of the code displayed to the user.

Clause 3. The method of clause 1, wherein the method further includes obtaining additional content from a source other than the predefined set of files based on the defined scope or context.

Clause 4. The method of clause 1, wherein the scope is based on historical user interactions.

Clause 5. The method of clause 1, wherein the scope is based on anticipated future use of the code.

Clause 6. The method of clause 1, wherein the context is based on code functionality.

Clause 7. The method of clause 1, wherein the context is a user profile context.

Clause 8. The method of clause 1, wherein the context is an application-specific context corresponding to an application associated with the code.

Clause 9. The method of clause 1, wherein the context is an enterprise or third-party context.

Clause 10. The method of clause 1, wherein the method further includes utilizing different font styles or highlighting to visually distinguish different code within the contextually partitioned coherent virtual file view of the partitioned code segments based on different scope or context.

Clause 11. The method of clause 1, wherein the method further includes presenting the contextually partitioned coherent virtual file view of the partitioned code segments in a first window concurrently while presenting a build view of the code in a second window.

Clause 12. The method of clause 1, wherein the method includes utilizing a machine learning model to identify the partitioned code segments that are determined to be relevant to the defined context and defined scope, the machine learning model being trained to identify probabilities that different portions of code are relevant to defined contexts and defined scopes.

Clause 13. The method of clause 1, wherein the code is contained within a single file.

Clause 14. The method of clause 1, wherein the code is contained within a plurality of discrete and separately stored files.

Clause 15. The method of clause 1, wherein each partitioned code segment includes at least a predetermined threshold of bounding lines of code, based on the defined scope, for any code that is determined to be relevant to the defined context.

Clause 16. The method of clause 1, wherein the method includes compiling the partitioned code segments independently from other code included in the identified code.

Clause 17. A method for dynamically modifying a presentation of partitioned code, the method comprising: displaying a contextually partitioned coherent virtual file view of partitioned code segments from code included in one or more source code files based on a defined context and a defined scope, the contextually partitioned coherent virtual file view of partitioned code segments omitting at some portions of the code included in the one or more source code files based on the defined context and the defined scope; detecting a change that results in a new defined context or a new defined scope for generating an updated contextually partitioned coherent virtual file view of partitioned code segments; in response to the detected change, generating the updated contextually partitioned coherent virtual file view of partitioned code segments, the updated contextually partitioned coherent virtual file view of partitioned code segments including a second set of code that is different than a first set of code included in the contextually partitioned coherent virtual file view of partitioned code segments; and displaying the updated contextually partitioned coherent virtual file view of partitioned code segments in a manner to visually distinguish the second set of code for the updated contextually partitioned coherent virtual file view of partitioned code segments from the first set of code for the contextually partitioned coherent virtual file view of partitioned code segments.

Clause 18. The method of clause 17, wherein the contextually partitioned coherent virtual file view of partitioned code segments is displayed in a first window concurrently with the display of the updated contextually partitioned coherent virtual file view of partitioned code segments in a second window.

Clause 19. The method of clause 17, wherein the method further includes replacing a display of the contextually partitioned coherent virtual file view of partitioned code segments with a display of the updated logical presentation of partitioned code segments.

Clause 20. The method of clause 17, wherein the method further includes compiling the first and second sets of code separately.

What is claimed:

1. A method for dynamically generating a logical presentation of partitioned code, the method comprising:
identifying code from a predefined set of files for presentation to a user within an IDE (integrated development environment);
identifying a defined context associated with the use of the code;
identifying a defined scope for generating a logical presentation of partitioned code based on the defined context;
based on (i) the defined context and (ii) the defined scope, partitioning the code to identify partitioned code segments of the code that are determined to be relevant to the defined context and within the defined scope for generating a contextually partitioned coherent virtual file view of the partitioned code segments, the partitioned code segments being distinguished from other portions of the code that are determined to be less relevant to the defined context and/or outside of the defined scope for generating the logical presentation of partitioned code;
generating a memory mapping for the partitioned code segments that identifies lines of the code to include with each partitioned code segment of the partitioned code segments; and
generating and displaying a contextually partitioned coherent virtual file view of the partitioned code segments based on the memory mapping that omits the other portions of the code.

2. The method of claim 1, wherein the method further includes reformatting at least some partitioned code segments in the contextually partitioned coherent virtual file view with different formatting than is used to present the code within a build view of the code displayed to the user.

3. The method of claim 1, wherein the method further includes obtaining additional content from a source other than the predefined set of files based on the defined scope or context.

4. The method of claim 1, wherein the scope is based on historical user interactions.

5. The method of claim 1, wherein the scope is based on anticipated future use of the code.

6. The method of claim 1, wherein the context is based on code functionality.

7. The method of claim 1, wherein the context is a user profile context.

8. The method of claim 1, wherein the context is an application-specific context corresponding to an application associated with the code.

9. The method of claim 1, wherein the context is an enterprise or third-party context.

10. The method of claim 1, wherein the method further includes utilizing different font styles or highlighting to visually distinguish different code within the contextually partitioned coherent virtual file view of the partitioned code segments based on different scope or context.

11. The method of claim 1, wherein the method further includes presenting the contextually partitioned coherent virtual file view of the partitioned code segments in a first window concurrently while presenting a build view of the code in a second window.

12. The method of claim 1, wherein the method includes utilizing a machine learning model to identify the partitioned code segments that are determined to be relevant to the defined context and defined scope, the machine learning model being trained to identify probabilities that different portions of code are relevant to defined contexts and defined scopes.

13. The method of claim 1, wherein the code is contained within a single file.

14. The method of claim 1, wherein the code is contained within a plurality of discrete and separately stored files.

15. The method of claim 1, wherein each partitioned code segment includes at least a predetermined threshold of bounding lines of code, based on the defined scope, for any code that is determined to be relevant to the defined context.

16. The method of claim 1, wherein the method includes compiling the partitioned code segments independently from other code included in the identified code.

17. A computing system comprising:
at least one hardware processor; and
at least one hardware storage device having stored computer-executable instructions that are executable by the at least one hardware processor for causing the computing system to perform a method for dynamically generating a logical presentation of partitioned code, the method comprising:
identifying code from a predefined set of files for presentation to a user within an IDE (integrated development environment);
identifying a defined context associated with the use of the code;
identifying a defined scope for generating a logical presentation of partitioned code based on the defined context;
based on (i) the defined context and (ii) the defined scope, partitioning the code to identify partitioned code segments of the code that are determined to be relevant to the defined context and within the defined scope for generating a contextually partitioned coherent virtual file view of the partitioned code segments, the partitioned code segments being distinguished from other portions of the code that are determined to be less relevant to the defined context and/or outside of the defined scope for generating the logical presentation of partitioned code;
generating a memory mapping for the partitioned code segments that identifies lines of the code to include with each partitioned code segment of the partitioned code segments; and
generating and displaying a contextually partitioned coherent virtual file view of the partitioned code segments based on the memory mapping that omits the other portions of the code.

18. The computing system of claim 17, wherein the method further includes reformatting at least some partitioned code segments in the contextually partitioned coherent virtual file view with different formatting than is used to present the code within a build view of the code displayed to the user.

19. The computing system of claim 17, wherein the method further includes utilizing different font styles or highlighting to visually distinguish different code within the contextually partitioned coherent virtual file view of the partitioned code segments based on different scope or context.

20. The computing system of claim 17, wherein the method further includes presenting the contextually partitioned coherent virtual file view of the partitioned code segments in a first window concurrently while presenting a build view of the code in a second window.
